(19) United States
(12) Patent Application Publication
(10) Pub. No.: US 2004/0154017 A1
(43) Pub. Date: Aug. 5, 2004

(54) A Method and Apparatus For Dynamically Allocating Process Resources

(75) Inventors: Philip G Emma, Danbury, CT (US); Allen P Haar, Essex Junction, VT (US); Paul D Kartschoke, Williston, VT (US); Barry W. Krumm, Poughkeepsie, NY (US); Norman J Rohrer, Underhill, VT (US); Peter A Sandon, Essex Junction, VT (US)

Correspondence Address: IBM MICROELECTRONICS, INTELLECTUAL PROPERTY LAW, 1000 RIVER STREET, 972 E, ESSEX JUNCTION, VT, 05452, US

(73) Assignee: International Business Machines Corporation, Armonk, NY

(21) Appl. No.: 10/248,600

(22) Filed: Jan. 31, 2003

(51) Int. Cl. G06F 9/46

(52) U.S. Cl. 718/100

(57) ABSTRACT

A computer system having a plurality of processors where each of the processors is dynamically assigned for execution of tasks based upon either performance or reliability.

### BACKGROUND OF INVENTION

1. Technical Field

The present invention generally relates to systems having multiple processors, and more particularly, to systems having multiple processors where the resources of the processors are dynamically allocated.

2. Related Art

In today's fast moving electronic based environments, the consumer has continued to demand both increased speed and increased reliability. In order to fulfill these desires, the industry has adopted an approach that uses redundant components in a system where parallel processing can be performed. Unfortunately, duplicated components of these systems have been designed in a static state so that they either operate in parallel for speed or perform redundant operations for reliability. If a user was not concerned about size or cost, these types of designs would suffice.

For example, multi-processor systems that support both reliability and performance are currently designed by assigning one set of dedicated processors for performance based operations, and another set of dedicated processors for reliability based operations. The cost associated with these additional redundant processors can become quite substantial. Furthermore, since the systems are static, the consumer is unable to change the configuration or allocation of the processors for either reliability or performance without purchasing a new system.

In yet another example, the performance of the processors themselves can also be increased by adding duplicate components (e.g. Floating point execution units) for parallel execution.

It would, therefore, be a distinct advantage to have an electronic device that has duplicate components that could be dynamically assigned to a task based upon either performance or reliability purposes. The present invention provides such a device.

### SUMMARY OF INVENTION

The present invention is applicable to any device that has duplicate components residing therein. The present invention dynamically assigns tasks to the duplicate components based upon either performance or reliability objectives.

In one aspect, the present invention is a computer system having a plurality of microprocessors where each one of the microprocessors is dynamically assigned a task based upon either performance or reliability.

In yet another aspect, the present invention is a processor having duplicate execution units where each one of the duplicate execution units is assigned a task based upon either performance or reliability.

### BRIEF DESCRIPTION OF DRAWINGS

The present invention will be better understood and its numerous objects and advantages will become more apparent to those skilled in the art by reference to the following drawings, in conjunction with the accompanying specification, in which:

FIG. 1 is a schematic diagram illustrating a multiprocessor system according to the teachings of a preferred embodiment of the present invention;

FIG. 2 is a flow chart illustrating the method that the Dynamic Instruction Control (DIC) unit of FIG. 1 uses for dynamically assigning the processors 1-N of FIG. 1 according to the teachings of the present invention; and

FIG. 3 is a schematic diagram illustrating the use of the dynamic instruction control unit at the execution unit level of a processor according to the teachings of the present invention.

### DETAILED DESCRIPTION

In the following description, well-known circuits have been shown in block diagram form in order not to obscure the present invention in unnecessary detail. For the most part, details concerning timing considerations and the like have been omitted inasmuch as such details are not necessary to obtain a complete understanding of the present invention, and are within the skills of persons of ordinary skill in the relevant art.

The present invention is applicable to any device that has duplicate components residing therein. The present invention dynamically assigns tasks to the duplicate components based upon either performance or reliability. Although specific embodiments are shown and described below for implementing such a device, the present invention is not intended to be limited to these particular embodiments, but is equally applicable to any device having duplicate components.

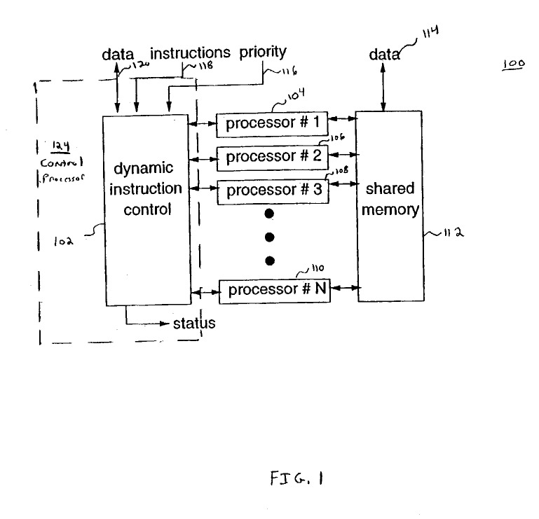

Reference now being made to FIG. 1, a schematic diagram is shown illustrating a multiprocessor system 100 according to the teachings of a preferred embodiment of the present invention. The multiprocessor system 100 includes processors 1-N (104-110), shared memory 112, a dynamic instruction control unit 102, and a control processor 124. The processors 1-N (104-110) execute and/or perform some number of logical operations, and each one has access to shared memory 112 to access identical data when required. Each processor 1-N (104-110) may be a single processing unit, or may itself be multiple processing units sharing a cache memory, and optionally can contain a checksum register for more granularity when required.

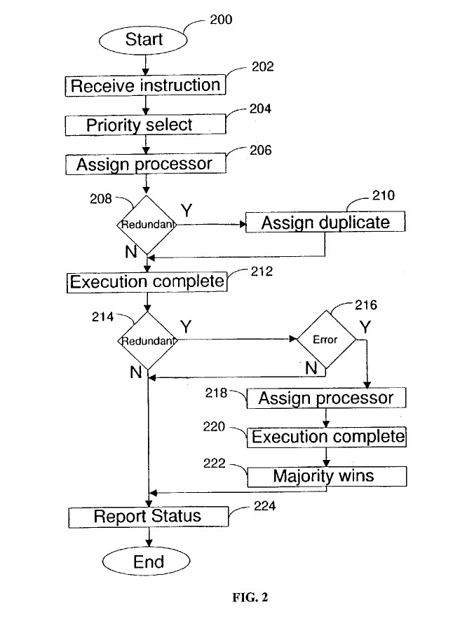

The dynamic instruction control unit 102 is illustrated as residing within the control processor 124, but it could also be a separate unit reporting the status to the control processor 124 as well. The dynamic instruction control unit 102 oversees the distribution of instructions and data, under normal and error conditions. The dynamic instruction control unit 102 is responsible for receiving data 120, instructions 118 to perform on the data 120, and a desired operation priority 116, and then to schedule the calculation and report the calculation status 122 back to the control processor 124. The control processor, then, is responsible for establishing the priority of instructions, and for handling unusual situations as indicated by the status, such as errors that cannot be resolved otherwise. The operation of the dynamic instruction control unit 102 is best explained by way of example, and is described as such in connection with FIG. 2.

FIG. 2 is a flow chart illustrating the method the Dynamic Instruction Control (DIC) unit 102 of FIG. 1 uses for dynamically assigning the processors 1-N (104-110) according to the teachings of the present invention. The function of the DIC unit 102 is best explained by way of example. Assume for the moment that the user has specified maximum speed without any redundancy (error protection). In this example, the DIC unit 102 receives a set of instructions for execution (step 202). The DIC unit 102 determines which instruction to execute next based on the corresponding priority values (step 204). The DIC unit 102 assigns the next available processor 1-N (104-110) to execute the highest priority instruction (step 206). There is no redundancy required (steps 208 and 214) so, once the execution completes (step 212), the status of the execution is reported to the control processor 124 (step 224). The above noted process would be repeated in this example for each instruction received by the DIC 102.

Now assume that the user has specified some level of redundancy for certain instructions such as calculations. When the DIC 102 receives one of these instructions (step 202), assuming no higher priority instruction is available (step 204), the next available processor 1-N (104-110) is assigned to execute the instruction (step 206). However, since the user has specified redundancy (step 208), the DIC also assigns at least one additional processor 1-N (104-110) for duplicate processing of the instruction. It should be noted that many different methods for ensuring redundancy can be used with the present invention (for example 3 processors from the start with voting at the end), and the particular method used in this example is not to be considered a limitation but merely an example of how such redundancy can be implemented.

Once execution has completed for the assigned processors 1-N (104-110), the results for the processors are compared one to another (steps 212, 214, and 216). If the results are different, then the DIC 102 assigns the next available processor 1-N (104-110) to execute the instruction a third time (step 218). After the execution completes (step 220), the DIC 102 compares the result to the results obtained from the previous two executions, and the matching result is used as correct and reported (step 224). If all of the results are different from one another, then an error condition is reported (step 224).

As a further example, assuming that multiple instructions are received by the DIC 102 where some have strict integrity constraints while others do not, the processors 1-N (104-110), can be dynamically assigned for the instructions accordingly. For example, in a 10 processor system, three high integrity processes can be assigned to six processors, while the other four processors can be assigned to the remaining instructions to achieve high throughput.

It should also be noted that the dynamic instruction control unit 102 can delay execution in one processor with respect to parallel execution in a second processor, in order to provide some immunity to more global transient sources of errors, such as voltage spikes.

While the previous examples have been focused on single instructions, a coarser granularity, at the process, task or transaction level is also supported by the dynamic instruction control unit 102. The point at which results must be compared (step 216) is the point at which a result is computed that is to be used outside the current computation. Transaction processing, for example, would require this comparison at the commit phase of processing.

To support the coarser granularity a checksum register in the processor is used to compute a checksum over a computation. First, a checksum register is cleared at the beginning of the computation. This is done with a synchronizing instruction that insures all instructions preceding it complete before this instruction executes. On each cycle, the checksum is updated using some function of the current checksum and the computation state. For example, the exclusive-or of the checksum register, the virtual data address, and the data stored for each store instruction would give a check of the results written to memory. Additional checking could include the instruction address and result data from computations, if the data of the processor, and not just the program output, is desired to match. At the end of the computation, a freeze checksum instruction causes the checksum register to hold its contents. This is also a synchronizing instruction.

The use of the checksum on a high reliability low worst case latency application, results, in the preferred embodiment, in each thread being dispatched to three processors. As each processor completes its checksum guarded computation, it stores the checksum and updates a semaphore. When the third processor completes the computation, it runs the checksum compare code. Assuming that at least two checksums match, the result of the calculation from one of those two matching processors is committed.

If lowest worst case latency is not critical, better throughput can be had using two of the N processors at a time for checksum guarded computation, and if an error is detected, a third processor is used to break the tie (similarly, in a single processor system, a checksum guarded computation can be executed twice, and checksums compared to detect an error, followed by a third iteration, if needed to break a tie.).

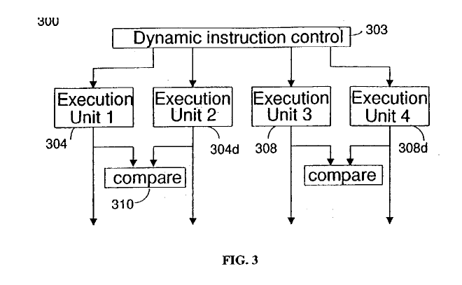

Reference now being made to FIG. 3, a schematic diagram is shown illustrating the use of another embodiment of the dynamic instruction control unit 303 at the execution unit level of a processor 300 according to the teachings of the present invention. In this particular embodiment, there would be two execution units of the same type (i.e. they perform the same function). Execution units 304 and 304d perform the same function, and 308 and 308d perform the same function between themselves which is different from that of 304 and 304d. The processor 300 includes a machine state bit 312 to indicate fault detect mode. If the fault detect mode is set, then the dynamic instruction control unit 303 operates in a manner similar to DIC 102 of FIG. 1. Mainly, that every instruction is sent to a similar pair (e.g. 304 and 304d) of execution units that have hardware compare logic 310 to check the two results. If the fault detect mode is off, then the dynamic instruction control unit 303 assigns different instructions to each execution unit of a similar pair, thus, allowing parallel execution and increasing throughput.

For example, it is common to design a superscalar processor with multiple instances of each type of execution unit to take advantage of instruction level parallelism and achieve high performance. With the fairly limited design change described here, such processors could be dynamically configured as high reliability processors whenever the application required it.

It should be noted that the processor implementation of FIG. 3 assumes that the software is indicating which sections of code are to be considered critical.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

1. a circuit comprising:
a first functional unit capable of performing a first function;
a second functional unit capable of performing the first function; and
a control unit to receive tasks and assign them for execution by the first and/or second functional unit based upon performance or reliability requirements of the received task.

2. The circuit of claim 1 wherein the control unit receives a first task requiring reliability and assigns the first task to the first and second functional units for execution.

3. The circuit of claim 2 wherein the results from the execution of the first task by the first and second functional units are different.

4. The circuit of claim 3 wherein the control unit assigns the first task for a second execution by the first unit.

5. The circuit of claim 4 wherein the control unit compares the result of the second execution of the first task with the previous results of the execution of the first task and chooses the matching results as the correct result.

6. The circuit of claim 2 wherein the control unit receives a second task and a third task each requiring performance, and assigns the second and third tasks to the first and second functional units.

7. The circuit of claim 1 wherein the control unit receives a first task and a second task each requiring performance, and assigns the first and second tasks to the first and second functional units.

8. The circuit of claim 7 wherein the control unit receives a third task requiring reliability, and assigns the third task to both the first and second functional units.

9. A microprocessor comprising:
a first unit capable of performing a first function;
a second unit capable of performing the first function; and
an instruction control unit to receive and assign instructions for execution by the first and/or second unit based upon reliability or performance requirements of the received instruction.

10. The microprocessor of claim 9 wherein the instruction control unit receives a first instruction having reliability requirements and assigns the first instruction for parallel execution by both the first and second units.

11. The microprocessor of claim 10 wherein the results of the execution of the first instruction by the first and second units are different.

12. The microprocessor of claim 11 wherein the instruction control unit assigns the first instruction for a second execution by the first unit.

13. The microprocessor of claim 12 wherein the instruction control unit chooses the result from execution of the first instruction that matches the result of the second execution of the first instruction by the first unit as the correct result.

14. The microprocessor of claim 10 wherein the instruction control unit receives second and third instructions each having performance requirements, and assigns the second and third instructions for execution by the first and second units, respectively.

15. The microprocessor of claim 14 further comprising:
a third unit capable of performing the first function; and
a fourth unit capable of performing the first function.

16. The microprocessor of claim 15 wherein the instruction control unit receives fourth, fifth and sixth instructions, the fourth instruction having reliability requirements, and the fifth and sixth instructions having performance requirements, the instruction control unit assigning the fourth instruction for execution by the first and second units, and assigning the fifth and sixth instructions for execution by the third and fourth units, respectively.

17. The microprocessor of claim 14 further comprising:
a third unit capable of performing the first function;
a fourth unit capable of performing the first function;
a fifth unit capable of performing a second function; and
a sixth unit capable of performing a second function.

18. The microprocessor of claim 17 wherein the instruction control unit receives fourth, fifth and sixth instructions, the fourth instruction having reliability requirements, and the fifth and sixth instructions having performance requirements, the instruction control unit assigning the fourth instruction for execution by the fifth and sixth units, and the fifth and sixth instructions for execution by the first and second units, respectively.

19. The microprocessor of claim 18 wherein the first function is a floating point operation.

20. The microprocessor of claim 19 wherein the second function is an arithmetic logic unit.
